(19) United States
(12) Patent Application Publication
(10) Pub. No.: US 2017/0155653 A1
(43) Pub. Date: Jun. 1, 2017

(54) USER-BASED DATA PROCESSING METHOD AND DEVICE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Pengyu GUO, Tianjin (CN)

(21) Appl. No.: 15/245,825

(22) Filed: Aug. 24, 2016

Related U.S. Application Data
(63) Continuation of application No. PCT/CN2016/087651, filed on Jun. 29, 2016.

(30) Foreign Application Priority Data
Nov. 26, 2015 (CN) 201510847086.6

(51) Int. Cl. H04L 29/06

(52) U.S. Cl. CPC H04L 63/10

(57) ABSTRACT

An embodiment of the present disclosure discloses a user-based data processing method and device. The method comprises steps of: determining a source user, a target user and authority contents to be shared according to an authority sharing message, wherein a first user authority of the source user is higher than a second user authority of the target user; modifying the authority time limit of the source user according to the authority contents to be shared, and generating a third user authority of the target user according to the authority contents to be shared; and when a target user requests limited resources, providing limited resources for the target user according to the third user authority. By implementing the above method, the problem of wasting resources due to incomplete use of the authority is solved.

### CROSS-REFERENCE TO RELATED APPLICATIONS

The present disclosure is a continuation of International Application No. PCT/CN2016/087651 filed on Jun. 29, 2016, which is based upon and claims priority to Chinese Patent Application No. 201510847086.6, entitled “USER-BASED DATA PROCESSING METHOD AND DEVICE”, filed on Nov. 26, 2015, the entire contents of all of which are incorporated herein by reference.

### TECHNICAL FIELD

The present disclosure generally relates to the field of network videos, in particular to a user-based data processing method and a user-based data processing device.

### BACKGROUND

Users can execute operations in application platforms by authority after being registered in the application platforms. However, the application platforms usually set user ratings, and users on different ratings have different user authority.

For example, after being registered in a video website, a user, namely a member, usually has the authority to watch and cache common videos, while a senior member has the authority of being free from advertisements and watching paid videos for free. For another example, a common user at an instant communication terminal executes interaction chatting, while a member can send senior emotions during chatting.

It is thus clear that, users on different ratings have different user authority on the website and at the client, but some senior users usually do not login the website or client, so the authority of the senior user is not fully utilized, thus causing waste in resources.

Therefore, a problem urgently needed to be solved by those skilled in this field is to provide a user-based data processing method and device for solving the problem of wasting resources caused by incomplete use of the authority.

### SUMMARY

An embodiment of the present disclosure discloses a user-based data processing method and a user-based data processing device for solving the problem of wasting resources caused by incomplete use of the authority.

According to one aspect of the present disclosure, an embodiment of the present disclosure discloses a user-based data processing method, including: determining a source user, a target user and authority contents to be shared according to an authority sharing message, wherein a first user authority of the source user is higher than a second user authority of the target user; modifying the authority time limit of the source user according to the authority contents to be shared, and generating a third user authority of the target user according to the authority contents to be shared; and when a target user requests limited resources, providing limited resources for the target user according to the third user authority.

Correspondingly, according to another aspect of the present disclosure, an embodiment of the present disclosure also discloses an electronic device for user-based data processing, including: at least one processor; and a memory communicably connected with the at least one processor for storing instructions executable by the at least one processor, wherein execution of the instructions by the at least one processor causes the at least one processor to: determine a source user, a target user and authority contents to be shared according to an authority sharing message, wherein a first user authority of the source user is higher than a second user authority of the target user; modify the authority time limit of the source user according to the authority contents to be shared, and generate a third user authority of the target user according to the authority contents to be shared; and when a target user requests limited resources, provide limited resources for the target user according to the third user authority.

According to another aspect of the present disclosure, the present disclosure discloses a non-transitory computer readable medium, storing executable instructions that, when executed by an electronic device, cause the electronic device to: determine a source user, a target user and authority contents to be shared according to an authority sharing message, wherein a first user authority of the source user is higher than a second user authority of the target user; modify an authority time limit of the source user according to the authority contents to be shared, and generate a third user authority of the target user according to the authority contents to be shared; supply the limited resources to the target user according to the third user authority when the target user requests limited resources.

The present disclosure has the following beneficial effects:

the embodiments of the present disclosure disclose a user-based data processing method and device. The method including steps of: determining a source user, a target user and authority contents to be shared according to an authority sharing message, wherein the first user authority of the source user is higher than the second user authority of the target user; modifying the authority time limit of the source user according to the authority contents to be shared, and generating the third user authority of the target user according to the authority contents to be shared; and when a target user requests limited resources, providing limited resources for the target user according to the third user authority. Therefore, the present disclosure realizes that users without authority can acquire the authority shared by the user with the authority, and also solves the problem of wasting resources caused by incomplete use of the authority.

The above description is a summary of the solution of the present disclosure. In order to clarify describe the technical means of the present disclosure, the content of the description can be executed. Moreover, in order to ensure that the above and other objectives, characteristics and advantages of the present disclosure are more understandable, embodiments of the present disclosure are described below.

### BRIEF DESCRIPTION OF THE DRAWINGS

To clearly describe the technical solution in the embodiments of the present disclosure or in the prior art, the following are brief introduction of the attached drawings used to describe the technology in the embodiments or in the prior art. Obviously, the attached drawings described below involve some embodiments of the present disclosure. For those originally skilled in this field, other drawings can be obtained according to those drawings without creative labor.

FIG. 1 is a step flow chart of a user-based data processing method according to one embodiment of the present disclosure.

FIG. 2 is a step flow chart of a user-based data processing method according to another embodiment of the present disclosure.

FIG. 3 is a structural block diagram of a user-based data processing device according to one embodiment of the present disclosure.

FIG. 4 is a structural block diagram of a user-based data processing device according to another embodiment of the present disclosure.

FIG. 5 schematically illustrates a block diagram of an electronic device for executing the method according to the present disclosure.

FIG. 6 schematically illustrates a memory cell for holding or carrying program codes for realizing the method according to the present disclosure.

### DETAILED DESCRIPTION

To clarify the objectives, technical solutions and advantage of the embodiments of the present disclosure, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, those ordinarily skilled in this field can obtain other embodiments without creative labor, which all shall fall within the protective scope of the present disclosure.

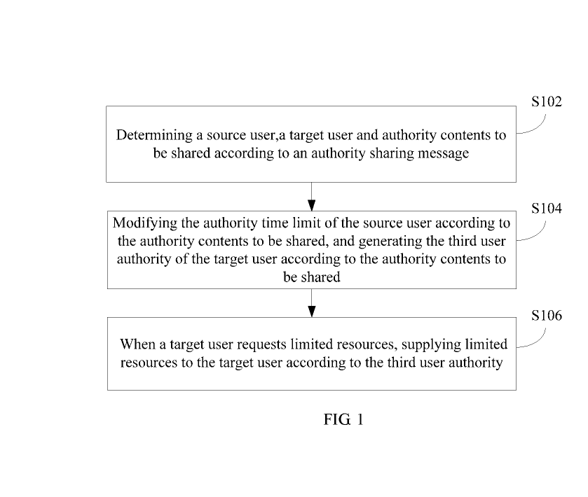

Refer to FIG. 1, which illustrates a step flow chart of a user-based data processing method according to one embodiment of the present disclosure. The method may specifically include steps as follows.

Step S102: Determine a source user, a target user and authority contents to be shared according to an authority sharing message.

When accessing the website of a video platform and a play client, a user can acquire access authority by registering membership, and defines the authority to resources as the user authority, wherein the user authority includes watch authority, downloading authority, advertisement-free authority, etc. Wherein, user authority varies with member ratings.

In order to ensure that the user authority of a senior member can be fully utilized, an embodiment of the present disclosure allows a senior member to share the authority to common members, wherein the authority sharing can be executed through an authority sharing message. For example, a source user can send an authority sharing message actively, or send an authority sharing message to share the authority on the basis of a request sent by a target user. Wherein, an authority sharing message includes authority contents to be shared, and all or a part of the authority of the first user authority can be shared.

After receiving the authority sharing message, a server can analyze the authority sharing message and obtains the source user, the target user and the authority contents to be shared from the authority sharing message. Wherein, the source user refers to the user who executes authority sharing, and usually is a senior member; and the target user refer to users acquiring the shared authority, are usually common members. The user authority of the source user, namely the senior member, is called the first use authority, while the user authority of the target user, namely common members, is called the second user authority, and the first user authority of the source user is higher than the second user authority of the target user.

Step S104: modify the authority time limit of the source user according to the authority contents to be shared, and generate the third user authority of the target user according to the authority contents to be shared.

The authority contents to be shared obtained by analyzing the authority sharing message are confirmed. After it is confirmed that the source user can share the authority contents, the authority contents to be shared can be converted through a preset conversion rule to obtain authority time limit corresponding to the share, and the authority time limit of the source user is modified, wherein the authority time limit is a time scope that the user owns, and is higher than the user authority of the second user authority, for example, the authority time limit of the source user, namely the time of the first user authority that the source user can use.

The user authority corresponding to the contents can also be determined according to the authority contents to be shared. The user authority as the third use authority is distributed to the target user. The third user authority is distributed to the target user. And, the time of the third user authority that the target user can use can be determined.

Therefore, the third user authority includes all or a part of the authority of the first user authority, and the third user authority is higher than the second user authority.

Step S106: when a target user requests limited resources, supply limited resources for the target user according to the third user authority.

When a target user accesses limited resources, wherein the limited resources refer to resources with limits in access, the second user authority has no authority of access to the limited resources, while the first user authority has the authority of access to the limited resources. After the sever receives the request message of access to the limited resource, the server checks the user authority of the target user according to the request message, and supplies the limited resources to the target user according to the third user authority.

In conclusion, the authority of the source user is shared to the target user through the authority sharing message such that the authority of the source user which is not fully utilized can be shared. The target user has the corresponding third user authority, so the target user can be supplied with the limited sources according to the third user authority when accessing the limited resources. Through authority sharing, the user authority is fully utilized, preventing resource waste.

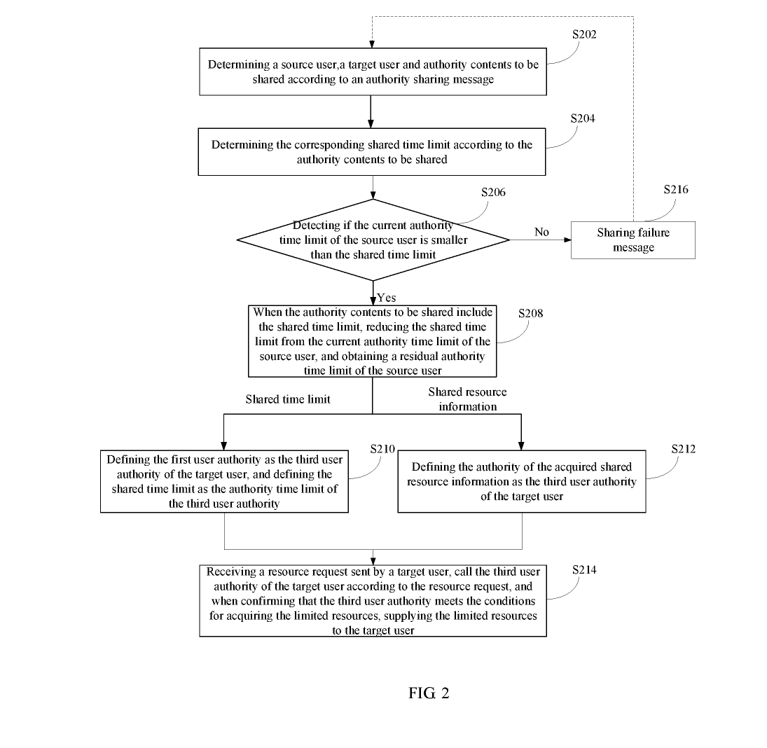

Refer to FIG. 2, which illustrates a step flow chart of a user-based data processing method according to another embodiment of the present disclosure. The method may specifically include steps as follows.

Step S202: Determine a source user, a target user and authority contents to be shared according to an authority sharing message.

In a video platform, user authority varies with user ratings, for example, a user can acquire a higher user rating by means of recharging, task accomplishment and recommendation to own higher user authority.

According to the embodiment of the present disclosure, the authority contents to be shared include: shared time limit and/or shared resource information, wherein the shared time limit can be a shared member time length, and the shared resource information can include sharing information of designated video resources. The first user authority of the source user includes authority of access to various resources, and the first user authority has an authority time limit to limit a user's time of authority use, so when sharing the authority, the source user can directly share the available time of the first user authority, namely adding the shared time limit in the authority contents to be shared, and can also share the authority of access to a part of the limited resources, namely adding the shared resource information in the authority contents to be shared.

Step S204: determine the corresponding shared time limit according to the authority contents to be shared.

Wherein, the server determines the corresponding time limit according to the contents to be shared, and the contents to be shared include three types:

1. The contents to be shared include the shared time limit only, for example member time length;

2. The contents to be shared include the shared resource information only, for example the number of films/TV series;

3. The contents to be shared include the shared time limit and the shared resource information, for example the member time length and the number of films/TV series.

According to an optimal embodiment of the present disclosure, the authority contents to be shared determines the corresponding shared time limit, including acquisition of the shared time limit from the authority contents to be shared, or, acquisition of the shared resource information from the authority contents to be share, converts the shared resource information into the shared time limit.

In the case that the contents to be shared include the shared resource information, the subsequent operation is determined, for example, when the authority contents to be shared includes the shared time limit, the shared time limit can be directly acquired from the authority contents to be shared, for another example, when the authority contents to be shared include the shared resource information, the shared resource information can be converted by a preset conversion rule, and then the shared time limit required it share the resource information is determined.

For example, if the contents to be shared are 10-day sharing, then it is directly determined that the source user shares 10 days of the senior membership authority to the target user. For another example, if the contents to be shared are four films/ TV series, the server converts the sharing of the films/TV series into a corresponding membership time length, and if the corresponding shared time limit of each film/TV series is 120 min, then the time limits of the four films/TV series is 480 min.

Step S206: detect if the current authority time limit of the source user is smaller than the shared time limit.

The server compares the shared time limit with the current authority time limit of the source user, determines if the authority time limit of the source user is sufficient to share the contents, and if so, which means that the current authority time limit of the source user is not smaller than the shared time limit, executes Step S208 to continue the sharing steps. If the current authority time limit of the source user is not sufficient, which means that the current authority time limit of the source user is smaller than the shared time limit, executes step S218.

Step S208: reduce the shared time limit from the current authority time limit of the source user, and obtain the residual authority time limit of the source user.

When the shared time limit is determined according to the contents to be shared and the current authority time limit of the source user is sufficient to share the contents, the server modifies the time limit of the source user to realize authority sharing, namely reducing the shared time limit from the current authority time limit of the source user, and by this time, the server records the residual authority time limit of the source user.

The contents shared by the source user can be the time limit and can also be source, so when the authority contents to be shared include the shared time limit, step S210 is executed, and when the authority contents to be shared include the shared resource information, step S212 is executed.

Step S210: Define the first user authority as the third user authority of the target user, and define the shared time limit as the authority time limit of the third user authority.

When the contents to be shared include the shared time limit, the server Define the first user authority of the source user as the third user authority of the target user, wherein, the third user authority includes all or a part of the authority of the first user authority, and the third user authority is higher than the second user authority. After the target user acquires the user authority, the shared time limit is defined as the available time of the third user authority of the target user, and the server records and stores such contents.

For example, a senior member user A has a 60 h membership time length and shares a 20 h membership time length to a common member user B; the server compares the shared membership time length with the membership time length of the senior member user A, makes confirmation, and then shares the 20 h membership time length to the common member user B; the server calculates that the residual time length of the senior member user A is 40 h, and the user B has the 20 h senior membership authority, namely owning 20 h third user authority.

Step S212: Define the authority of the acquired shared resource information as the third user authority of the target user.

When the contents to be shared include the shared resource information, the server defines the authority of the shared resource information as the third user authority of the target user after determining the residual authority time limit of the target user, wherein the first user authority of the source user includes the third user authority of the target user, and the third user authority does not exceed the first user authority. The shared time limit corresponding to the shared resource information is defined as the available time of the third user authority of the target user, and the server records and stores such contents.

Wherein, the shared resource information can include the shared information of the designated video resources, wherein after sharing is completed, the target user can acquire the access authority of the sharing information of the designated video resources.

For another example, a senior member user A has a 60 h membership time length, and shares four films/TV series to a common member user B. The shared resource information is converted by a preset rule, wherein the time length of every film/TV series is 120 min, and the shared time limit is 480 min, namely 8 h; then, the residual authority time limit of the senior member user A is 52 h, while the common member user B obtains the third user authority which is the access to the four films/TV series; and the shared time limit is correspondingly set, for example the shared time limit is 8 h time length for the four films/TV series, and for another example, the shared time limit is the 52 h residual time length for the senior member user.

For another example, a senior member user A has a 60 h membership time length, and the 20 h membership time length and four films/TV series are shared to a common member user B, which means that the authority contents to be shared include 20 h and four films/TV series, wherein the time length of every film/TV series is 120 min, and the shared time limit is (20+120*4/60) 28 h. Then, the residual authority time limit of the senior member user A is 32 h, while the common member user B obtains the third user authority including access to all limited resources in 20 h, and the authority of access to the four films/TV series within the residual 32 h of the senior member user A.

Step S214: Receive a resource request sent by a target user, call the third user authority of the target user according to the resource request, and when confirming that the third user authority meets the conditions for acquiring the limited resources, supply the limited resources to the target user.

When the target user requests the limited resources, wherein the limited resources refer to resources with limits in access, the second user authority has no authority of access to the limited resources, while the first user authority has the authority of access to the limited resources.

The target user sends the resource request to the server, wherein the resource request message includes authority and authority time limit; the server analyzes the resource request message, calls the third user authority, distributed to the target user by the server, according to the resource request, and when confirming that the third user authority meets the conditions for acquiring the limited resources, supply the limited resources to the target user, and the limited resources is limited by time.

Wherein, the conditions of the acquisition include: the third user authority distributed to the target user by the server can acquire the limited resources, and that the shared time limit does not exceed the time limit of the limited time resources.

Step S216: Generate a sharing failure message.

When the current authority time limit of the source user is smaller than the shared time limit, a sharing failure message is generated and fed back to the source user such that the source user determines the contents to be shared again.

The sharing failure message is used for re-determining sharing or canceling the sharing, wherein the re-determination of sharing includes: division of the consent to be shared again to ensure that the authority time limit determined by the consent to be shared does not exceed the current authority time limit of the source user, or the sharing is canceled.

By implementing the above embodiment of the present disclosure, the authority of the user is shared to the target user according to the authority sharing message such that the authority of the source user which is not fully utilized can be shared. The target user has the corresponding third user authority, so the target user can be supplied with the limited sources according to the third user authority when accessing the limited resources. Through authority sharing, the user authority is fully utilized, preventing resource waste.

It is needed to be noted that, for simple description, the method embodiments are described as a series of action combinations, but those skilled in this field understand that the embodiments of the present disclosure are not limited by the sequence of the described actions because according to the embodiments of the present disclosure, some steps can be implemented in other sequence or at the same time. Moreover, those skilled in this field also understand that the embodiments described in the present disclosure all belong to optimal embodiments, and some actions involved are not always needed by the embodiments of the present disclosure.

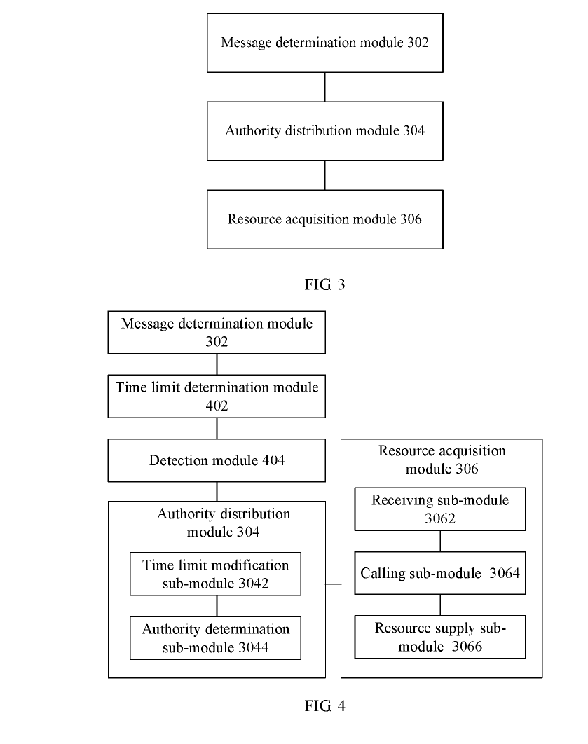

Refer to FIG. 3, which illustrates a structural block diagram of a use-based data processing device according to one embodiment of the present disclosure. The device may specifically include the following modules:

a message determination module 302 for determining a source user, a target user and authority contents to be shared according to an authority sharing message, wherein a first user authority of the source user is higher than a second user authority of the target user; an authority distribution module 304 for modifying the authority time limit of the source user according to the authority contents to be shared, and generating a third user authority of the target user according to the authority contents to be shared; and a resource acquisition module 306 for, when a target user requests limited resources, providing limited resources for the target user according to the third user authority.

Wherein, the message determination module 302 is used for receiving the authority sharing message, wherein the authority message can include the authority sharing message actively sent by the source user or the authority sharing message requested by the target user, and analyzing the authority message to obtain the source user, the target user and the authority contents to be shared.

The authority distribution module 304 is used for confirming the authority contents to be shared obtained by analyzing the authority sharing message; converting the authority contents to be shared into a corresponding authority time limit, wherein the authority contents to be shared can be converted according to a preset rule; and modifying the authority time limit of the source user according to the corresponding authority time limit, wherein the authority time limit is defined as measurement of the authority of the source user. The user authority corresponding to the contents can also be determined according to the authority contents to be shared. The user authority as the third use authority is distributed to target user. The third user authority is distributed to the target user, wherein the authority time limit corresponding to the authority contents to be shared is defined as the measurement of the third user authority.

The resource acquisition module 306 is used for, when the target user accesses the limited resources, wherein the limited resources can be contents that the source user can obtain through the first user authority resources and that the target user cannot obtain through the second user authority. After the sever receives the request message of access to the limited resource, the server checks the user authority of the target user according to the message, and supplies the limited resources to the target user according to the third user authority, wherein the authority time length corresponding to the contents to be shared is defined as the measurement.

The device embodiment of the present disclosure is implemented according to the method embodiments, realizing users without authority to obtain the authority shared by the user with the authority, and avoiding the problem of wasting resources due to incomplete use of the authority.

The device embodiment is basically the same as the method embodiments and therefore is simply described. Related contents can be seen in the related description of the method embodiments.

Refer to FIG. 4, which illustrates a structural block diagram of a user-based data processing device according to another embodiment of the present disclosure. The device may specifically include the modules as follows.

A message determination module 302 for determining a source user, a target user and the authority contents to be shared according to the authority sharing message, wherein the first user authority of the source user is higher than the second user authority of the target user; a time limit determination module 402 for determining the corresponding shared time limit according to the authority contents to be shared, acquiring the shared time limit from the authority contents to be shared, or acquiring the shared resource information from the authority contents to be shared, and converting the shared resources information into the shared time limit; a detection module 404 for detecting if the current authority time limit of the source user is smaller than the shared time limit, executing the step of modifying the authority time limit of the resource user when the current authority time limit of the source user is not smaller than the shared time limit, generating a sharing failure message and feeding the message back to the source user if the current authority time limit of the source user is smaller than the shared time limit, so that the source user determines the contents to be shared again; a time limit modification sub-module 3042 for reducing the shared time limit from the current authority time limit of the source user and obtaining the residual authority time limit of the source user; an authority determination sub-module 3044 for defining the first user authority as the third user authority of the target user and defining the shared time limit as the authority time limit of the third user authority when the authority contents to be shared include the shared time limit, and for defining the acquired shared resource information as the third user authority of the target users when the authority contents to be shared included the shared resource information; a receiving sub-module 3062 is used for receiving a resource request sent by the target user, wherein the resource request is a command for requesting limited resources; a calling sub-module 3064 for calling the third user authority of the target user according to the resource request; and a resource supply sub-module 3066 for supplying limited resources to the target user when confirming that the third user authority meets conditions for acquiring the limited resources.

The time limit determination module 402 is used for analyzing contents to be shared in turn to obtain the corresponding shared contents, and converting the shared contents into the corresponding shared time limit, wherein the contents to be shared includes the three following types:

1. The contents to be shared include the shared time limit only, for example member time length;

2. The contents to be shared include the shared resource information only, for example the number of films/TV series;

3. The contents to be shared include the shared time limit and the shared resource information, for example the member time length and the number of films/TV series.

Upon the shared resource information included by the contents to be shared, the resource information can be converted by a preset lute, wherein the final conversion result is a corresponding authority time limit.

The authority distribution module 304 includes the time limit modification sub-module 3042 and the authority determination sub-module 3044.

When the contents to be shared include the shared time limit only, the time limit modification sub-module 3042 performs addition and subtraction on the time limit of the source user, namely reducing the shared time limit from the authority time limit of the source user, and obtains the residual authority time limit of the source user, and the server records the residual authority time limit of the source user. When the contents to be shared include the shared resource information only, the time limit modification sub-module 3042 analyzes the shared resource information, converts the shared resource information into a corresponding authority time limit, wherein in this embodiment, a conversion rule is preset, and determines the time limit required by each kind of shared resources, for example, films, TV series, etc. The server performs addition and subtraction on the time limit of the source user, namely reducing the shared time limit from the authority time limit of the source user, and obtains the residual authority time limit of the source user, and the server records the residual authority time limit of the source user.

When the contents to be shared include the shared time limit only, the authority determination sub-module 3044 defines the first user authority of the source user as the third user authority of the target user, wherein the first user authority includes the third user authority, and the third user authority does not exceed the first user authority. When the contents to be shared include shared resource information, the authority determination sub-module 3044, defines the authority of the shared resource information as the third user authority of the target user after determining the residual authority time limit of the target user, wherein the first user authority of the source user includes the third user authority of the target user, and the third user authority does not exceed the first user authority. The shared time limit corresponding to the shared resource information is defined as the available time of the third user authority of the target user. The above contents are recorded and stored.

The resource acquisition module 306 includes the receiving sub-module 3062, the calling sub-module 3064 and the resource supply sub-module 3066.

The receiving sub-module 3062 receives a target user's request for accessing limited resources, wherein the limited resources refer to resources with limits in access, the second user authority has no authority of access to the limited resources, while the first user authority has the authority of access to the limited resources. The resource request message includes authority and authority time limit. The server analyzes the resource request message. The calling sub-module 3064 calls the third user authority, distributed to the target user by the server, according to the resource request. When confirming that the third user authority meets the conditions for acquiring the limited resources, the resource supply sub-module 3066 supplies the limited resources to the target user, and the limited resources is limited by time.

Wherein, the conditions of the acquisition include: the third user authority distributed to the target user by the server can acquire the limited resources, and that the shared time limit does not exceed the time limit of the limited time resources.

The device embodiment of the present disclosure is implemented according to the method embodiments, realizing users without authority to obtain the authority shared by the user with the authority, and avoiding the problem of wasting resources due to incomplete use of the authority.

The device embodiment described above is schematic, wherein units described as separable parts may be or may be not physically separated, and components displayed as units may be or may be not physical units, which means that the units can be positioned at one place or distributed on a plurality of network units. Some or all modules can be selected to fulfill the objective of the solution in the embodiment upon actual demands. Those ordinarily skilled in this field can understand and implement the present disclosure without creative work.

All embodiments of the present disclosures are described in a progressive manner. Every embodiment focuses on different factors. Identical and similar parts of the embodiments can be reference of one another.

In addition, it should be noted that, although in the above illustration a server is taken as an example, in practical application, the present disclosure may also be applied to various electronic devices, which is not limited to be the server.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

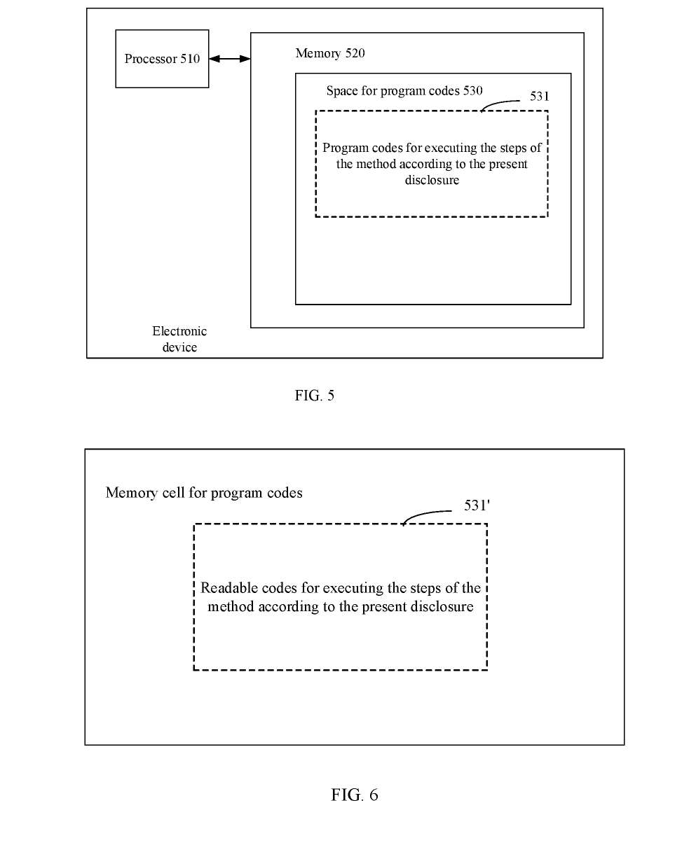

For example, FIG. 5 illustrates a block diagram of an electronic device for executing the user-based data processing method according the disclosure. The electronic device may be the server above. Traditionally, the electronic device includes a processor 510 and a computer program product or a computer readable medium in form of a memory 520. The memory 520 could be electronic memories such as flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the electronic device as shown in FIG. 5. The program codes may be compressed for example in an appropriate form. Usually, the memory cell includes computer readable codes 531′ which can be read for example by processors 510. When these codes are operated on the electronic device, the electronic device may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

The embodiments of the present disclosure are described with reference to the flow charts and/or block diagrams of the methods and terminal devices (system) and computer program products of the embodiments of the present disclosure. It should be understood that the computer program commands realize every process and/or block in the flow charts and/or block diagrams and the combination of processes and/or blocks in the flow charts and/or block diagrams. The computer program command can be supplied to the processor of a universal computer, a special computer, an embedded processing machine or other programmable data processing terminals to generate a machine, so the commands executed by the processor of the computer or other programmable data processing terminals generate a device for realizing specific functions in one or more processes in the flow charts and/or one or more blocks in the block diagrams.

The computer program commands can also be stored in computer readable memories which guide the computer or other data processing terminal devices to work in a specific mode, so the commands stored in the computer readable memories generate products including command devices, and the command devices conduct specific functions in one or more processes in the flow charts and/or one or more blocks in the block diagrams.

The computer program commands can also be loaded in the computer or other programmable data processing terminal devices such that computer or other programmable processing terminal devices execute a series of operations to generate processing executed by the computer. Thus, the commands executed in the computer or other programmable terminal devices supply processes of conducting specific functions in one or more processes in the flow charts and/or one or more blocks in the block diagrams.

The present disclosure describes a data processing method and a data processing device in detail. In the text, specific examples are used to describe the principle and implementation modes of the present disclosure. The above embodiments are used to describe instead of limiting the technical solution of the present disclosure; although the above embodiments describe the present disclosure in detail, those ordinarily skilled in this field shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A user-based data processing method, at an electronic device, comprising:
determining a source user, a target user and authority contents to be shared according to an authority sharing message, wherein a first user authority of the source user is higher than a second user authority of the target user;
modifying an authority time limit of the source user according to the authority contents to be shared, and generating a third user authority of the target user according to the authority contents to be shared; and
when the target user requests limited resources, supplying limited resources to the target user according to the third user authority.

2. The method according to claim 1, wherein, after determining the source user, the target user and the authority contents to be shared according to the authority sharing message, the method further comprises:
determining the corresponding shared time limit according to the authority contents to be shared;
detecting if the current authority time limit of the source user is smaller than the shared time limit;
when detecting if the current authority time limit of the source user is not smaller than the shared time limit, executing the step of modifying the authority time limit of the source user.

3. The method according to claim 2, further comprising:
when the current authority time limit of the source user is smaller than the shared time limit, generating a sharing failure message and feeding the sharing failure message back to the source user such that the source user determines the contents to be shared again.

4. The method according to claim 2, wherein the step of determining the corresponding shared time limit according to the authority contents to be shared comprises:
acquiring the shared time limit from the authority contents to be shared, or, acquiring the shared resource information from the authority contents to be share, and converting the shared resource information into the shared time limit.

5. The method according to claim 4, wherein the step of modifying the authority time limit of the source user according to the authority contents to be shared, and generating the third user authority of the target user according to the authority contents to be shared comprises:
reducing the shared time limit from the current authority time limit of the source user, and obtaining a residual authority time limit of the source user;
when the authority contents to be shared comprise the shared time limit, defining the first user authority as the third user authority of the target user, and defining the shared time limit as the authority time limit of the third user authority;
and when the authority contents to be shared comprise shared resource information, defining the authority of the acquired shared resource information as the third user authority of the target user.

6. The method according to claim 5, wherein, when the target user requests limited resources, the step of supplying the limited resources to the target user according to the third user authority comprises:
receiving a resource request sent by the target user, wherein the resource request is a command for requesting limited resources;
calling the third user authority of the target user according to the resource request;
when confirming that the third user authority meets conditions for acquiring the limited resources, supplying limited resources to the target user.

7. An electronic device for user-based data processing, comprising:
at least one processor; and
a memory communicably connected with the at least one processor for storing instructions executable by the at least one processor, wherein execution of the instructions by the at least one processor causes the at least one processor to:
determine a source user, a target user and authority contents to be shared according to an authority sharing message, wherein a first user authority of the source user is higher than a second user authority of the target user;
modify an authority time limit of the source user according to the authority contents to be shared, and generate a third user authority of the target user according to the authority contents to be shared;
supply the limited resources to the target user according to the third user authority when the target user requests limited resources.

8. The electronic device according to claim 7, wherein execution of the instructions by the at least one processor causes the at least one processor to further:
determine the corresponding shared time limit according to the authority contents to be shared;
detect if the current authority time limit of the source user is smaller than the shared time limit, and trigger an authority distribution module when the current authority time limit of the source user is not smaller than the shared time limit.

9. The electronic device according to claim 8, wherein,
execution of the instructions by the at least one processor causes the at least one processor to further: when the current authority time limit of the source user is smaller than the shared time limit, generate a sharing failure message and feed the sharing failure message back to the source user such that the source user determines the contents to be shared again.

10. The electronic device according to claim 8, wherein,
execution of the instructions by the at least one processor causes the at least one processor to further: acquire the shared time limit from the authority contents to be shared, or, acquire the shared resource information from the authority contents to be share, and convert the shared resource information into the shared time limit.

11. The electronic device according to claim 10, wherein modify an authority time limit of the source user according to the authority contents to be shared, and generate a third user authority of the target user according to the authority contents to be shared comprises:
reduce the shared time limit from the current authority time limit of the source user, and obtain a residual authority time limit of the source user;
define the first user authority as the third user authority of the target user and define the shared time limit as the authority time limit of the third user authority when the authority contents to be shared comprise the shared time limit, and define the authority of the acquired shared resource information as the third user authority of the target user when the authority contents to be shared comprise shared resource information.

12. The electronic device according to claim 11, wherein supply the limited resources to the target user according to the third user authority when the target user requests limited resources comprises:
receive a resource request sent by the target user, wherein the resource request is a command for requesting limited resources;
call the third user authority of the target user according to the resource request;
supply limited resources to the target user when confirming that the third user authority meets conditions for acquiring limited resources.

13. A non-transitory computer readable medium storing executable instructions that, when executed by an electronic device, cause the electronic device to:
determine a source user, a target user and authority contents to be shared according to an authority sharing message, wherein a first user authority of the source user is higher than a second user authority of the target user;
modify an authority time limit of the source user according to the authority contents to be shared, and generate a third user authority of the target user according to the authority contents to be shared;
supply the limited resources to the target user according to the third user authority when the target user requests limited resources.

14. The non-transitory computer readable medium according to claim 13, wherein, after determining the source user, the target user and the authority contents to be shared according to the authority sharing message, the electronic device is further caused to:
determine the corresponding shared time limit according to the authority contents to be shared;
detect if the current authority time limit of the source user is smaller than the shared time limit;
when detecting if the current authority time limit of the source user is not smaller than the shared time limit, execute the step of modifying the authority time limit of the source user.

15. The non-transitory computer readable medium according to claim 14, wherein the electronic device is further caused to:
when the current authority time limit of the source user is smaller than the shared time limit, generate a sharing failure message and feed the sharing failure message back to the source user such that the source user determines the contents to be shared again.

16. The non-transitory computer readable medium according to claim 14, wherein determine the corresponding shared time limit according to the authority contents to be shared comprises:
acquire the shared time limit from the authority contents to be shared, or, acquire the shared resource information from the authority contents to be share, and convert the shared resource information into the shared time limit.

17. The non-transitory computer readable medium according to claim 16, wherein modifying the authority time limit of the source user according to the authority contents to be shared, and generate the third user authority of the target user according to the authority contents to be shared comprises:
reduce the shared time limit from the current authority time limit of the source user, and obtain a residual authority time limit of the source user;
when the authority contents to be shared comprise the shared time limit, define the first user authority as the third user authority of the target user, and define the shared time limit as the authority time limit of the third user authority; and
when the authority contents to be shared comprise shared resource information, define the authority of the acquired shared resource information as the third user authority of the target user.

18. The non-transitory computer readable medium according to claim 17, wherein, when the target user requests limited resources, supply the limited resources to the target user according to the third user authority comprises:
receive a resource request sent by the target user, wherein the resource request is a command for requesting limited resources;
call the third user authority of the target user according to the resource request;
when confirming that the third user authority meets conditions for acquiring the limited resources, supply limited resources to the target user.
